(19) United States
(12) Patent Application Publication
(10) Pub. No.: US 2009/0212945 A1
(43) Pub. Date: Aug. 27, 2009

(54) INTRUSION DETECTION SYSTEMS FOR DETECTING INTRUSION CONDITIONS WITH RESPECT TO ELECTRONIC COMPONENT ENCLOSURES

(76) Inventor: Michael L. Steen, San Jose, CA (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/037,283

(22) Filed: Feb. 26, 2008

(51) Int. Cl. G08B 13/00

(52) U.S. Cl. 340/541

(57) ABSTRACT

Intrusion detection systems for detecting intrusion conditions with respect to electronic component enclosures are disclosed herein. An intrusion detection system in accordance with the subject matter disclosed herein may include a conductive component that at least partially surrounds a space. The conductive component may cover at least a portion of an electronic component to be protected. Further, the system may include a first conductive trace positioned to contact the conductive component. A second conductive trace may include a portion positioned in the space at least partially surrounded by the conductive component. The system may also include a detection circuit for determining whether at least one of the first conductive trace and the conductive component are not conductively connected and for determining that the second conductive trace is conductively connected to the first conductive trace. Further, the detection circuit may detect an intrusion condition in response to determining at least one of the first conductive trace and the conductive component are not conductively connected.

### TECHNICAL FIELD

The subject matter disclosed herein generally relates to tamper detection and protection of enclosures. More particularly, the subject matter disclosed herein relates to intrusion detection systems for detecting intrusion conditions with respect to enclosures.

### BACKGROUND

In many electronic or computer applications, it is desirable to protect data or circuitry from unwanted, unlawful, or unauthorized access. Intrusion detection measures have been implemented for detecting such access attempts and for taking steps to protect against the attempts. As different intrusion detection measures become known, intruders are able to devise and implement techniques for circumventing such measures. Accordingly, it is desirable to provide improved or alternative intrusion detection measures for preventing the circumvention of existing measures.

Computer hardware and other electronic circuitry may be protected from tampering by placing the hardware or circuitry in a casing, such as a metal case. Such a protection measure provides a physical barrier against tamper attempts. A casing alone, however, may be vulnerable to physical attacks such as drilling through the casing or prying the casing open to gain access to hardware or circuitry. Therefore, additional or substitute measures have been developed for preventing intruder access to hardware or circuitry.

Other intrusion detection measures include electronic systems. Such systems may detect intrusion attempts and, in response to the detection, take action to erase sensitive data contained in enclosed hardware or circuitry or other steps for preventing intruder access. One such system includes a conductive pad that is compressed onto printed circuit board (PCB) traces for connecting to an intrusion detection circuit. The conductive pad may cover or enclose sensitive hardware or circuitry. An intruder may attempt to gain access to the hardware or circuitry by removing the conductive pad. If the conductive pad is moved from the PCB traces, a conductive path between the conductive pad and one or more traces is broken and, in response to detection of the broken path, detection circuitry may determine that the occurrence of an intrusion and may take action to prevent access.

Problems exist with measures using a conductive pad because such measures may be circumvented by skillful intruders. One problem with known systems that use a conductive pad is that an aperture may be drilled near the interface of the conductive pad and the traces, and conductive ink may be injected in the aperture. The injected conductive ink may short the traces together to circumvent the detection circuitry. Further, a conductive pad measure may be circumvented by inserting a metal shim or wedge under the conductive pad to short the traces together. Thus, it is desirable to provide additional or substitute measures for detecting intrusions and for preventing access to protected hardware or circuitry.

For the reasons set forth above, improved intrusion detection systems for detecting attempts to gain access to a protected enclosure are desirable.

### SUMMARY

According to one aspect, intrusion detection systems for detecting intrusion conditions with respect to enclosures are disclosed herein. An intrusion detection system may include a conductive component that at least partially surrounds a space. The conductive component may cover at least a portion of an electronic component to be protected. Further, the system may include a first conductive trace positioned to contact the conductive component. A second conductive trace may include a portion positioned in the space at least partially surrounded by the conductive component. The system may also include a detection circuit for determining whether at least one of the first conductive trace and the conductive component are not conductively connected, for determining that the second conductive trace is conductively connected to the first conductive trace, and for detecting an intrusion condition in response to determining at least one of the first conductive trace and the conductive component are not conductively connected.

According to another aspect, an intrusion detection system may include a conductive component and a first conductive trace in contact at an interface. Second and third conductive traces may be spaced from the interface of the conductive component and the first conductive trace. Further, the system may include a detection circuit adapted to determine that the first conductive trace is not conductively connected to the conductive component. The detection circuit may also be adapted to determine that the second and third conductive traces are conductively connected for detecting an intrusion condition.

### BRIEF DESCRIPTION OF THE DRAWINGS

Preferred embodiments of the subject matter described herein will now be explained with reference to the accompanying drawings of which:

FIG. 1 is a schematic diagram of an intrusion detection system for detecting intrusion into an enclosure according to embodiment of the subject matter disclosed herein;

FIG. 2 is a top view of a conductive component according to an embodiment of the subject matter disclosed herein;

FIG. 3 is a top view of an exemplary configuration of traces, and trace portions according to an embodiment of the subject matter disclosed herein;

FIG. 4 is a top view of an exemplary configuration of traces, a conductive component, and trace portions according to an embodiment of the subject matter disclosed herein; and

FIG. 5 is a side view of an intrusion detection system for detecting intrusion into an enclosure according to embodiment of the subject matter disclosed herein.

### DETAILED DESCRIPTION

Intrusion detection systems are disclosed that employ conductive components, conductive traces, and detection circuits for detecting intrusion into a protected enclosure. In particular, the intrusion detection systems disclosed herein detect attempts to gain access to protected electronic data, circuitry, computer hardware, or other protected components from unwanted, unlawful, or unauthorized access. A detection circuit may determine whether a conductive component is conductively connected to a conductive trace or determine whether conductive traces are connected together for detecting an intrusion condition. On detection of an intrusion condition, the detection circuit may generate and transmit a signal indicating the intrusion condition. Further, the signal may cause one or more electronic components to be erased.

As used herein, the terms “conductive component” refers to a component or object having the ability to conduct. The term “conductive trace” refers to a line or wire formed in or on a substrate to form an electrically conductive path. Conductive components and conductive traces may be made of metals and/or semimetals. Further, conductive components may have one or more surfaces adapted to contact portions of conductive traces for providing an electrical conduit between the traces. A conductive trace may be a trace on a PCB that has a conductive pad formed to contact a conductive component.

As used herein, the term “detection circuit” refers to a circuit adapted to detect an intrusion condition. For example, a detection circuit may detect an intrusion into a protected enclosure. A detection circuit may detect an intrusion by determining that a conductive trace and a conductive component are not conductively connected. For example, the conductive trace and the conductive component may be connected in a safe state when there has been no tampering with an enclosure. When there is tampering, the conductive component may be moved such that it no longer contacts the conductive trace. The detection circuit may detect this occurrence and be alerted to an intrusion condition. Further, a detection circuit may detect an intrusion by determining that conductive traces are conductively connected. For example, the conductive traces may be unconnected in a safe state when there has been no tampering with an enclosure. When there is tampering, a conductive shim, a metal wedge, or conductive ink may cause the traces to be conductively connected. The detection circuit may detect this occurrence and be alerted to an intrusion condition.

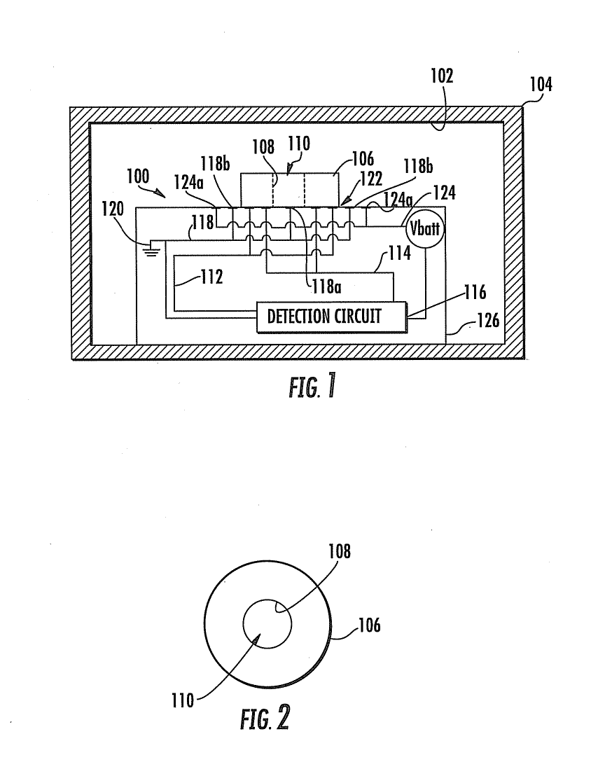

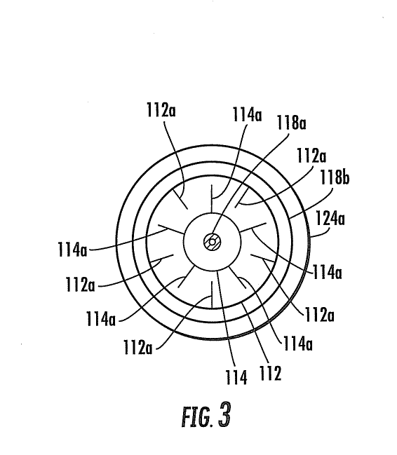

FIG. 1 is a schematic diagram of an intrusion detection system generally designated 100 for detecting intrusion into an enclosure according to embodiment of the subject matter disclosed herein. In particular, system 100 may detect attempts to gain access to electronic data, circuitry, computer hardware, or other components contained in an enclosure defined by an interior surface 102 of a container 104. Container 104 may be a hollow parallelepiped structure that surrounds one or more electronic components. In FIG. 1, a section view of container 104 is presented so that components in the interior of container 104 are visible. System 100 includes a conductive component (shown in a side view) 106 having a surface (indicated by broken lines) 108 that forms an aperture and at least partially surrounds a space generally designated 110. For example, component 106 may be an annular member that forms an inner region for enclosing an electronic component. Further, conductive component 106 may be made of any suitable conductive material, such as a metal, and any suitable shape and size. FIG. 2 is a top view of conductive component 106 according to an embodiment of the subject matter disclosed herein. In FIG. 2, it can be seen that component 106 includes an inner space or region 110 defined by surface 108 for holding an electronic component.

Returning to FIG. 1, container 104 may partially or entirely enclose system 100 and the components protected by system 100. Container 104 may be made of any suitable hard material, such as a metal or a hard plastic, for making the container difficult to penetrate, such as with a drill, shim, or wedge. Further, container 104 may be formed of two or more pieces secured together with screws, rivets, or other suitable components.

System 100 may include a number of intrusion detection measures for preventing access to an enclosure or for protecting circuitry or data stored in the enclosure. In one measure, system 100 includes conductive traces 112 and 114 positioned to contact conductive component 106 for conductively connecting the conductive traces via the conductive component. In particular, conductive traces 112 and 114 may include conductive pads positioned to contact one or more surfaces of conductive component 106 when arranged within container 104. A detection circuit 116 is operable to determine whether a conductive path exists between traces 112 and 114. If conductive component 106 is separated from one of or both traces 112 and 114, the conductive path between the traces is broken and an intrusion is detected by circuit 116. In this instance it may be assumed that if conductive component 106 has been moved that the contents of container 104 have been tampered with. For example, an intruder may have moved component 106 to access components covered or enclosed by component 104.

Detection circuit 116 may be configured to determine that the conductive path between traces 112 and 114 is broken. In one example, detection circuit 116 may apply current through traces 112 and 114 and conductive component 106. Further, detection circuit 116 may include circuitry for determining interruption of the applied current. If it is determined that the current is interrupted, it may be assumed that component 106 has been moved such that component 106 no longer contacts one of or both the traces. In this instance, it may also be assumed that the interruption in contact has resulted from tampering with the contents of container 104. Thus, detection of the current interruption results in an intrusion condition.

As a result of determining an intrusion condition, detection circuit 116 may take steps for preventing access to the enclosure or for protecting circuitry or data. In one example, detection circuit 116 may generate and transmit a signal indicating the detected intrusion condition. The signal may be generated to another electronic component for taking action to prevent access to the enclosure or for protecting circuitry or data. For example, the signal may cause another component to erase data stored on one or more other electronic components. As a result, an intruder may be prevented from accessing the data.

In another intrusion detection measure for preventing access to the enclosure or for protecting circuitry or data, system 100 may include a third conductive trace 118 including a conductive portion 118a positioned in space 110 surrounded by conductive component 106. Trace 118 may be grounded at terminal 120. If conductive trace 118 is conductively connected to one of or both traces 112 and 114, the connected trace 112 and/or 114 will be grounded. Trace 118 may be conductively connected to one of or both traces 112 and 114 by the injection of conductive ink or fluid into or around space 110 such that the conductive ink provides a conductive connection between trace 112 and one of or both the other traces. Further, during use for gaining access to protected components, a conductive shim or a conductive wedge may contact trace 118 and one of or both traces 112 and 114 such that traces 112 and 114 are grounded.

Detection circuit 116 may be configured to detect that trace 112 and/or trace 114 are grounded by trace 118. In particular, detection circuit 116 may include circuitry configured to determine when trace 112 or trace 114 is at a predetermined voltage level or range (e.g., at a ground voltage level or near a ground voltage level). On detection that trace 112 and/or trace 114 are grounded, detection circuit 100 may determine that an intrusion condition has been detected and take steps to prevent access to the enclosure, such as by generating and transmitting a signal indicating the detected intrusion condition.

Trace 118 may also include a portion 118b that surrounds an interface generally designated 122 of a surface of conductive component 106 and traces 112 and 114. Alternatively, trace portion 118b may substantially surround interface 122. Trace portion 118b is spaced from interface 122, component 104, and traces 112 and 114 such that trace portion 118b is not conductively connected to component 106 or traces 112 and 114. As set forth above, detection circuit 116 may detect that trace 112 and/or trace 114 are grounded. The grounding of trace 112 and/or trace 114 may occur when trace portion 118b is conductively connected to one of or both traces 112 and 114 by the injection of conductive ink or fluid near interface 122 such that the conductive ink provides a conductive connection between trace portion 118b and one of or both the other traces. Further, during use for gaining access to protected components, a conductive shim may contact trace portion 118b and one of or both traces 112 and 114 such that traces 112 and 114 are grounded. Detection circuit 116 may detect the grounding and thereby determine that an intrusion condition has occurred.

In another intrusion detection measure for preventing access to the enclosure or for protecting circuitry or data, system 100 may include a fourth conductive trace 124 having a portion 124a that surrounds an interface 122. Alternatively, trace 124 may substantially surround interface 122. Trace 124 is spaced from interface 122, component 104, and traces 112 and 114 such that trace 124 is not conductively connected to component 106 or traces 112 and 114. Further, trace 124 may be connected to Detection Circuit 116 and/or a sensitive voltage source having a voltage V_{batt} that would sense minor voltage variances or transients and trigger the protection function(s). Trace 124 may be spaced from trace 118. Detection circuit 116 may be configured to determining shorting of traces 118 and 124. On detection of the shorting, detection circuit 116 may determine that an intrusion condition has occurred.

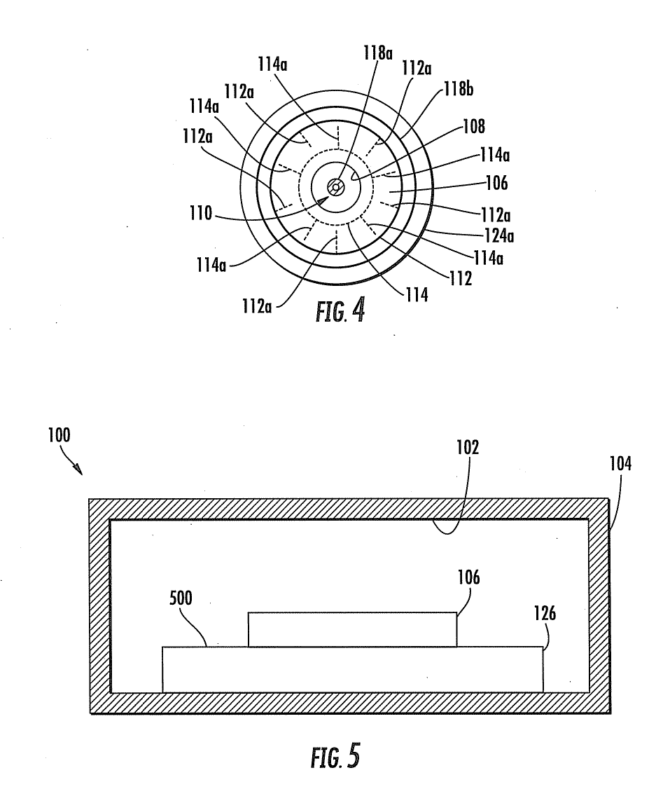

FIGS. 3 and 4 are top views of an exemplary configuration of traces 112 and 114, conductive component 106, and trace portions 118a, 118b, and 124a according to an embodiment of the subject matter disclosed herein. Referring to FIGS. 3 and 4, trace portions 118b and 124a are each circular in shape and concentrically positioned with respect to one another, trace portion 118a and traces 112 and 114. Further, the traces and trace portions are concentrically positioned with respect to the conductive component (designated 106 in FIG. 2). Traces 112 and 114 are in contact with the conductive component. Trace portions 118a, 118b, and 124a are spaced from one another and conductive component and traces 112 and 114 such that they are not conductively connected.

Further, traces 112 and 114 include portions 112a and 114a, respectively, which extend toward one another in an integrated spoke-like pattern. The close spacing and integration of traces 112 and 114 facilitate the reliability of conduction between traces 112 and 114 by component 106. By closely spacing and integrating the traces 112, 118, and 124, it is difficult for an intruder to attempt to gain access by use of conductive ink or liquid or a shim because the traces are more readily conductively connected. Thus, such intruder attempts are more easily recognized by a detection circuit.

Referring now to FIG. 1, the conductive traces may be integrated with a PCB 126 and may be a part of PCB 126. PCB 126 may be contained within the enclosure of container 104 and may include portions that are protected by system 100. In particular, portions or all of PCB 126 may be covered by conductive component 106 such that these portions of the PCB are inaccessible except by physically removing conductive component 106. In the case of the removal of conductive component 106, detection circuit 116 detects an intrusion condition as set forth above. Further, in the case of an attempt to circumvent the intrusion detection measure provided by conductive component 106, such as by use of a shim or conductive liquid, traces may be shorted with one another or with the conductive component. Detection circuit 116 may also detect this shorting for detection of an intrusion condition. Thus, the traces and detection circuit disclosed herein provides additional intrusion detection measures for preventing access to an enclosure or for protecting circuitry or data with the enclosure.

FIG. 5 is a side view of intrusion detection system 100 for detecting intrusion into an enclosure according to embodiment of the subject matter disclosed herein. In FIG. 5, conductive component 106 may cover at least a portion of an electronic component to be protected. The protected electronic component may be electronics of PCB 126. Conductive traces (not shown) may be positioned on a top surface 500 of PCB 126. At least some of the conductive traces may be configured with a detection circuit (not shown) as described herein for use in detecting unwanted access to the protected electronic components.

Although the components shown in FIGS. 2-4 are circular shaped in these examples, the components may alternatively be configured in any other suitable shape. For example, one or more of components 106, 112, 114, 118a, 118b, and 124a may be wholly or partially shaped as an oval, rectangle, or any irregular shape. These components may be suitable shaped based on one or more of the number, placement of electronic components to be protected, and the area to be protected.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. An intrusion detection system comprising:
a conductive component that at least partially surrounds a space, the conductive component for covering at least a portion of an electronic component to be protected;
a first conductive trace positioned to contact the conductive component;
a second conductive trace including a portion positioned in the space at least partially surrounded by the conductive component; and
a detection circuit for determining whether at least one of the first conductive trace and the conductive component are not conductively connected, for determining that the second conductive trace is conductively connected to the first conductive trace, and for detecting an intrusion condition in response to determining at least one of the first conductive trace and the conductive component are not conductively connected.

2. The intrusion detection system of claim 1 wherein the conductive component forms an aperture that at least partially surrounds the second conductive trace.

3. The intrusion detection system of claim 2 wherein the conductive component includes a surface, the aperture is formed in the surface, and the first conductive trace contacts the surface.

4. The intrusion detection system of claim 3 wherein the first conductive trace contacts a portion of the surface that substantially surrounds the aperture.

5. The intrusion detection system of claim 1 wherein the conductive component covers at least a portion of the electronic component.

6. The intrusion detection system of claim 1 wherein the conductive component is movable such that the conductive component is not contacting the first conductive trace, and wherein the conductive component and the first conductive trace are not conductively connected when the conductive component and the first conductive trace are not contacting.

7. The intrusion detection system of claim 1 wherein the second conductive trace is grounded, wherein the first conductive trace is grounded when the first and second conductive traces are conductively connected, and wherein the detection circuit is adapted to determine that the first conductive trace is grounded for detecting the intrusion condition.

8. The intrusion detection system of claim 1 wherein the detection circuit is adapted to detect interruption of current through the first conductive trace and the conductive component for detecting the intrusion condition.

9. The intrusion detection system of claim 1 wherein the detection circuit is adapted to generate and transmit a signal indicating the detected intrusion condition.

10. The intrusion detection system of claim 9 wherein the signal causes one or more electronic components to be erased.

11. The intrusion detection system of claim 1 comprising a third conductive trace positioned to contact the conductive component such that the first and third conductive traces are conductively connected via the conductive component, and wherein the detection circuit is adapted to determine that the first and third conductive traces are not conductively connected for detecting the intrusion condition.

12. The intrusion detection system of claim 11 wherein the conductive component forms an aperture substantially surrounded by a surface of the conductive component, wherein the first and second conductive traces contact the surface and substantially surround the aperture.

13. The intrusion detection system of claim 12 wherein the portions of the first and second conductive traces contacting the surface of the conductive component are integrated.

14. The intrusion detection system of claim 1 wherein the conductive component comprises an annular member defining a central aperture, wherein, in a non-tampered state, the second conductive trace is electrically isolated from the conductive component by the aperture, and in a tampered state the second conductive trace is electrically connected to the annular member.

15. The intrusion detection system of claim 1 wherein the conductive component comprises an annular member defining a central aperture, and wherein the first conductive trace annularly contacts the annular member around the aperture in a non-tampered state.

16. An intrusion detection system comprising:
a conductive component and a first conductive trace in contact at an interface, the conductive component for covering at least a portion of an electronic component to be protected;
second and third conductive traces being spaced from the interface of the conductive component and the first conductive trace; and
a detection circuit for determining whether at least one of that the first conductive trace is not conductively connected to the conductive component and that the second and third conductive traces are conductively connected, and for detecting an intrusion condition in response to determining that at least one of the first conductive trace is not conductively connected to the conductive component and the second and third conductive traces are conductively connected.

17. The intrusion detection system of claim 16 wherein the second and third conductive traces substantially surround the interface of the conductive component and the first conductive trace.

18. The intrusion detection system of claim 16 wherein the second conductive trace is grounded, the third conductive trace is connected to a voltage source, and the detection circuit is adapted to determine that current flow between the second and third conductive traces for detecting the intrusion condition.

19. The intrusion detection system of claim 16 wherein the detection circuit is adapted to determine that the second conductive trace is conductively connected to the conductive component for detecting the intrusion condition.

20. The intrusion detection system of claim 16 wherein the detection circuit is adapted to generate and transmit a signal indicating the detected intrusion condition.

21. The intrusion detection system of claim 20 wherein the signal causes one or more electronic components to be erased.

22. The intrusion detection system of claim 16 comprising fourth conductive trace, wherein the conductive component at least partially surrounds a portion of the fourth conductive trace, wherein the detection circuit is adapted to determine that the fourth conductive trace and the conductive component are conductively connected for detecting an intrusion condition.

23. The intrusion detection system of claim 16 wherein the conductive component is movable such that the conductive component is not contacting the first conductive trace, and wherein the conductive component and the first conductive are not conductively connected when the conductive component and the first conductive trace are not contacting.

24. The intrusion detection system of claim 16 wherein the second conductive trace is grounded, wherein the first conductive trace is grounded when the first and second conductive traces are conductively connected, and wherein the detection circuit is adapted to determine that the first conductive trace is grounded for detecting the intrusion condition.

25. The intrusion detection system of claim 16 wherein, in a non-tampered state, the second conductive trace is electrically isolated from the conductive component, and in a tampered state the second conductive trace is electrically connected to the conductive component.
